(19) United States
(12) Patent Application Publication
(10) Pub. No.: US 2005/0135520 A1
(43) Pub. Date: Jun. 23, 2005

(54) Multi-branch radio frequency amplifying apparatus and method

(76) Inventor: Kevin Gamble, Fort Lauderdale, FL (US)

Correspondence Address: Larson & Associates, P.C., 221 East Church Street, Frederick, MD, 21701-5405, US

(21) Appl. No.: 10/744,477

(22) Filed: Dec. 23, 2003

(51) Int. Cl. H04B 1/10

(52) U.S. Cl. 375/349

(57) ABSTRACT

A radio frequency level detector having extended uniform dynamic range contains a branching circuit that receives a radio frequency signal and sends it to at least two separate branches. One branch contains a fixed attenuator coupled to a rectifier, to create a rectified output that is proportional to the envelope of the radio frequency signal. The rectified signal is fed to a number of serially coupled limiting amplifier stages, and after each amplification stage the output is converted from a voltage signal to a current signal. All of the current signals are subsequently summed. This provides a current output signal that increases monotonically as a function of radio frequency power over a the first part of the dynamic range and remains constant as a function of radio frequency power over the second part of the range. The second of the two separate branches contains another fixed attenuator, which is larger than the previous fixed attenuator. The attenuated signal is fed to a radio frequency level detector circuit to create a current output signal that is constant as a function of radio frequency power over the first part of the range and increases monotonically as a function of radio frequency power over the second part of the range. This current output signal is summed along with the current signal from the first branch to provide a single current output signal that increases monotonically as a function of radio frequency power over the entire dynamic range.

### FIELD OF THE INVENTION

This invention relates generally to radio frequency amplifiers, and more particularly, to multiple branched radio frequency level detectors having extended uniform dynamic range.

### BACKGROUND

Logarithmic amplifiers can be divided into two basic classifications. These classifications are ‘true’ logarithmic amplifiers and demodulating logarithmic amplifiers. Generally speaking, demodulating logarithmic amplifiers provide the logarithm of the envelope of an input signal, and true logarithmic amplifiers provide the logarithm of the entire signal. For this reason, true logarithmic amplifiers are often referred to as ‘baseband’ logarithmic amplifiers, because they generally operate on ‘pulse’ type waveforms. Each type of logarithmic amplifier faces its own set of design challenges. For example, if a baseband log-amp is to resolve very short pulses or accurately track rapidly varying amplitude information, the dynamic range and the group delay as a function of input level are of prime concern. The dynamic range and group delay both relate to how accurately changes in ‘instantaneous’ power can be resolved (in timing and in log-magnitude), however large operational bandwidth is not required to accommodate an intermediate frequency (IF) or radio frequency (RF) carrier. In this case, the main design tradeoff is between the allowable input dynamic range and the maximum allowable group delay variation. In a situation where a demodulating logarithmic amplifier must provide the average power in an RF carrier without the aid of a down-conversion operation, bandwidth and input dynamic range are the chief concerns. Group delay variations are not important, because it is not necessary to resolve the fine detail of the envelope variations when computing a long-term ‘power’ average. Therefore the main design tradeoff is between the input dynamic range and the maximum allowable carrier frequency. Probably the most challenging applications for logarithmic amplifiers involve either the implementation of very wide bandwidth ‘true’ logarithmic amplifiers, or in performing fast video detection on a signal modulated by a carrier frequency. For the latter application, a logarithmic amplifier must be able to accommodate the desired carrier frequencies, and it must provide low group delay variation over the entire input dynamic range. In this case, maximum allowable carrier frequency, maximum allowable group delay variation, and allowable input dynamic range must be considered equally.

Some prior art solutions to this set of problems utilize a branched pair of power detectors. However these prior art solutions that fall under the classification of ‘extended dynamic range level-detectors’ generally require that the circuit adapt itself to the level of the input signal through the use of internal variable attenuators. The use of the variable attenuators and the implementation of all of the associated control logic adds an additional layer of complexity to the device.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIGS. 1-3 are electrical schematic diagrams of branched radio frequency amplifiers consistent with certain embodiments of the present invention.

FIG. 4 is a graph of amplifier output versus radio frequency power input for a branched radio frequency amplifier consistent with certain embodiments of the present invention.

### DETAILED DESCRIPTION

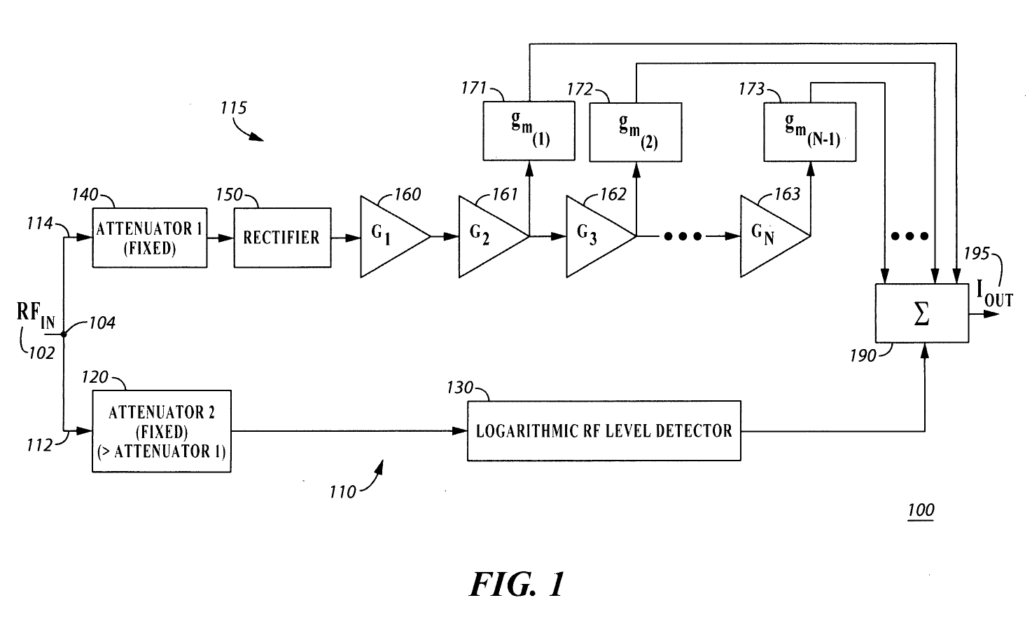

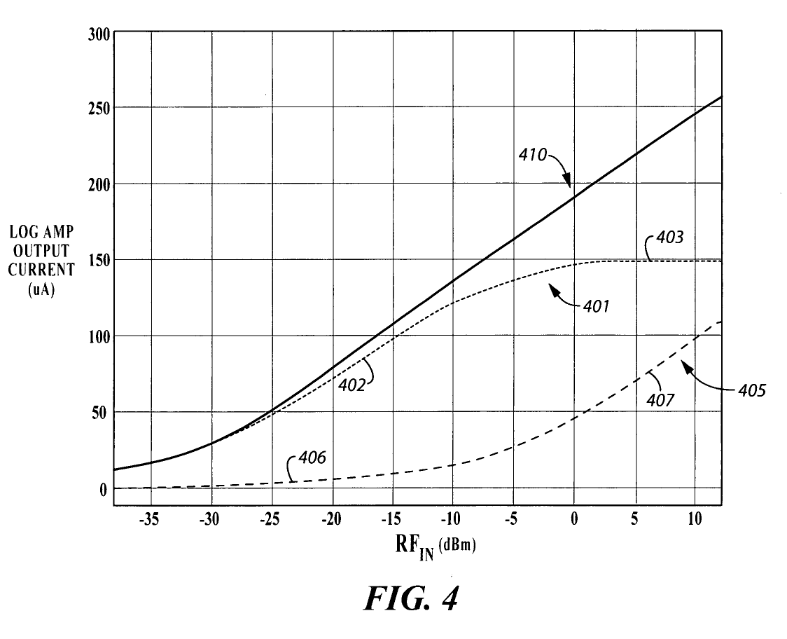

The invention is intended to extend the useful dynamic range of a demodulating logarithmic amplifier. A radio frequency level detector having extended uniform dynamic range contains a branching circuit that receives a radio frequency signal and sends it to two or more separate branches. One branch contains a fixed attenuator coupled to a rectifier, to create an attenuated rectified output that is proportional to the envelope of the radio frequency signal. The rectified signal is fed to a number of serially coupled limiting amplifier stages, and after each amplification stage the output is converted from a voltage signal to a current signal. All of the current signals are subsequently summed. This provides a current output signal that increases uniformly as a function of radio frequency power over a the first part of the dynamic range and remains constant as a function of radio frequency power over the second part of the range. The second of the two separate branches contains another fixed attenuator, which is larger than the previous fixed attenuator. The attenuated signal is fed to a radio frequency level detector circuit to create a current output signal that is nearly constant as a function of radio frequency power over the first part of the range and increases uniformly as a function of radio frequency power over the second part of the range. This current output signal is summed along with the current signals from the first branch to provide a single output current signal that increases smoothly and uniformly as a function of radio frequency power over the entire dynamic range. While this invention is susceptible of embodiment in many different forms, there is shown in the drawings and will herein be described in detail, specific embodiments, with the understanding that the present disclosure is to be considered as an example of the principles of the invention and not intended to limit the invention to the specific embodiments shown and described. In the description below, like reference numerals are used to describe the same, similar or corresponding elements in the several views of the drawings. When designing an RF level detector the chief design tradeoff involves the minimum required input dynamic range and the maximum required carrier frequency. When applied to existing logarithmic RF level detectors, the architecture in this section provides greater flexibility in performing this tradeoff. Referring now to FIG. 1, a radio frequency level detector 100 is arranged to receive an RF signal 102 at an input node 104. The RF signal 102 is split into two signals 112, 114 and sent to two parallel branches 110, 115 of the detector 100. The first or upper branch 115 contains a means for attenuating a signal 140, such as an attenuator, coupled to a rectifying means or rectifier 150 coupled to a plurality of serially coupled amplifying means such as limiting amplifier stages 160-163 and a plurality of voltage-to-current converters (gₘ) 171-173. The fixed attenuator 140 receives the RF signal 102, attenuates it at a predetermined value, and then passes the attenuated signal to the rectifier 150, where it is rectified to create a rectified signal that is proportional to the envelope of the radio frequency signal 102. The means for rectifying can be a half-wave rectifier, a full wave rectifier, or a squaring cell. The rectified signal is then passed to a series of N limiting amplifiers 160, 161, 162, 163 that are serially connected, output of one to the input of the next (i.e. head to tail). Each limiting amplifier, with the exception of the first, has associated with it a transconductance cell (voltage-to-current converter) 171, 172, 173 at the output of the amplifier. In practice, there can be any number of N amplifiers and N-1 voltage-to-current converters, where N is an integer equal to or greater than two (2). Each sequential amplification stage increases the level of the RF signal, and after each amplification stage, the signal is passed to the next amplifier in the chain, and (except for the first amplifier) it is also passed to an associated means for converting, such as a transconductance cell, where the voltage signal is converted to a current signal. Each of the transconductance cells passes their current signals to a common means for summing all of the current signals, such as a summing cell 190 that totals all the values to create a summed value for the amplified upper branch signal. The result of this manipulation of the original RF signal 102 is a current signal that increases monotonically as a function of radio frequency power over a first range of RF power, and at a certain point, stops increasing and remains substantially constant as a function of RF power over the remainder of the power range. This phenomena can be seen in graphical form in FIG. 4, where the curve 401 represents the output current as a function of RF input power for the upper branch 115 of the level detector 100. Note that the first portion 402 of the curve increases smoothly and generally monotonically as the RF power increases, up to approximately −10 dBm, whereupon the slope of the curve decreases and it flattens out in the second portion 403 to remain essentially constant over further increases in RF power. The terms ‘monotonic’ and ‘monotonically’ are commonly understood to refer to functions between partially ordered sets. A mathematical function is said to be monotonically increasing if, whenever x≦y, then f(x)≦(y). An increasing function is also called order-preserving for obvious reasons. Likewise, a function is decreasing if, whenever x≦y, then f(x)≧f(y). A decreasing function is also called order-reversing. If the definitions hold with the inequalities (≦,≧) replaced by strict inequalities (<, >) then the functions are called strictly increasing or strictly decreasing. Those of ordinary skill in the art will appreciate that the transition between the first range and the second range is not abrupt, but the slope of the curve changes continually over a brief intermediate span of RF power.

Returning now to FIG. 1, the second or lower branch 110 of the radio frequency level detector 100 contains a fixed attenuator 120 coupled to a logarithmic RF level detector 130. This fixed attenuator 120 receives the raw RF signal 112 and has an attenuation factor that is larger than the fixed attenuator 140 in the upper or first branch. The reason for this is to produce an output that is essentially flat over the first portion or range of the power curve. The attenuator 120 clips the RF signal so severely that the output is very small compared to the respective output of the first or upper branch of the circuit over the same range of RF power input. The output level is close to zero over much of this range, although it does increase slightly near the higher end of the region. The output does not have to be zero, but it is important that it be very small in relation to the output value of the upper branch in this same RF power region, so as to not contribute substantially to the overall summed current output. The fixed attenuator 120 then passes the attenuated signal to the logarithmic RF level detector 130, such as a successive compression detector, where it is amplified and converted into a current signal. A successive compression detector is but one type of circuit that may be employed as a logarithmic RF level detector 130. This amplified second signal is then passed to the summing cell 190 where it is summed along with the current values from the upper or first branch 115 to produce a combined current output 195 for the radio frequency level detector 100. Referring again to FIG. 4 where the curve 405 depicts the output current as a function of RF input power for the lower branch 110 of the level detector 100, note that the first portion 406 of the curve is essentially flat and remains generally constant as the RF power increases, up to approximately −10 dBm, whereupon the curve increases smoothly and generally monotonically in the second portion 407 over further increases in RF power. Note that the current output (y axis values) of the first portion 406 of the lower branch 110 are very small compared to the respective values in the first portion 402 of the upper branch 115 output. At the left end of the curve, the values approximate zero, and increase only marginally until about −10 dBm. Generally, the current output values of the lower branch are less than one tenth of the value of respective portions of those of the upper branch over the first range. When the current signals 401, 405 for both the upper and lower branches are summed at the summing cell 190 to produce a combined output 195, the two curves become superimposed to create the result depicted in the topmost curve 410 in FIG. 4. Note that the combined current output signal 410 increases smoothly and monotonically as a function of radio frequency power over the entire range of RF power (the first range and the second range and the intermediate transition region). FIG. 4 demonstrates that the instant invention achieves nearly ideal log-linear performance over an input RF power range of −38 dBm to 12 dBm. Through proper choice of the amplifier gains and transconductance values in the upper branch, the transition between the upper and lower branches is essentially unseen. The upper branch output 401 demonstrates the effect of omitting the transconductance cell at the input and output of the first limiting amplifier 160. For values of RF_{IN}>˜−7 dBm, the upper branch forms an output current ‘pedestal’ 403 on which the output current 407 from the lower branch is superimposed. It should be noted that both branches in FIG. 1 are operational at all input power levels. Therefore, no variable attenuators (and no associated control logic) are required in order to select the appropriate branch as a function of input power level.

Although the embodiment depicted here contains two branches, the structure is easily expanded to incorporate additional branches. Each of the additional branches must be of the same form as the upper branch in FIG. 1. This means that each additional branch can have an arbitrary number of limiting amplifier stages, however the transconductance cells cannot be placed at the input or output of the first amplifier in the chain. This restriction is necessary so that the additional branch outputs will saturate at a given output current (i.e. form a ‘pedestal’ for another branch).

The structure depicted in FIG. 1 can also be modified by performing linear full wave or half wave rectification in a distributed manner between the individual limiting amplifier stages. For example, rectification can be performed at the input to each limiting amplifier. In essence, the rectified output of each limiting amplifier is further rectified at the input to the following limiting amplifier.

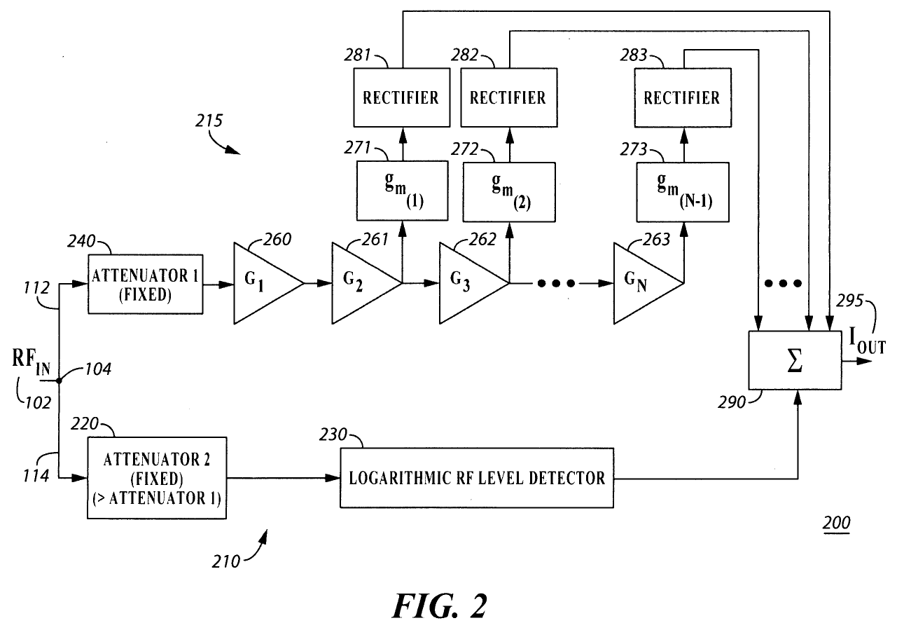

FIG. 2 describes an alternate embodiment of the invention previously described. A radio frequency level detector 200 is arranged to receive an RF signal 102 at an input node 104. The RF signal 102 is split into two signals 112, 114 and sent to two parallel branches 210, 215 of the detector 200. The first or upper branch 215 contains a fixed attenuator 240 coupled to a plurality of serially coupled limiting amplifier stages 260, 261, 262, 263 and a plurality of voltage-to-current converters 271, 272, 273. The fixed attenuator 240 receives the RF signal 102, attenuates it at a predetermined value, and then passes the attenuated signal to a series of N (where N is an integer greater than 2) limiting amplifiers that are serially connected, output of one to the input of the next. Each limiting amplifier, with the exception of the first, has associated with it a transconductance cell (voltage-to-current converter) 271, 272, 273 at the output of the amplifier. Each sequential amplification stage increases the level of the RF signal, and after each amplification stage, the signal is passed to the next amplifier in the chain, and it is also passed to an associated transconductance cell, where the voltage signal is converted to a current signal. Each of the transconductance cells in turn passes their current signals to an associated linear rectifier 281, 282, 283, and each rectified signal is then passed to a common summing cell 290 that sums up all the values to create a summed value for the amplified upper branch signal. The result of this manipulation of the original RF signal 102 is a current signal that increases monotonically as a function of radio frequency power over a first range of RF power, and at a certain point, stops increasing and remains substantially constant as a function of radio frequency power over the remainder of the power range. FIG. 4 depicts this in graphic form, where the curve 401 represents the output current as a function of RF input power for the upper branch 215 of the level detector 200. Note that the first portion 402 of the curve increases smoothly and generally monotonically as the RF power increases, up to a transition region between −10 dBm and 0 dBm, whereupon the curve flattens out in the second portion 403 to remain essentially constant over further increases in RF power.

Returning back to FIG. 2, the second or lower branch 210 of the radio frequency level detector 200 contains a fixed attenuator 220 coupled to a logarithmic RF level detector 230. This fixed attenuator 220 receives the raw RF signal and has an attenuation factor that is larger than the fixed attenuator 240 in the upper or first branch. The reason for this is to produce an output that is essentially flat over the first portion or range of the power curve. The attenuator 220 alters the RF signal such that the output is very small compared to the respective output of the first or upper branch of the circuit over the same range of RF power input. The fixed attenuator 220 then passes the attenuated signal to the logarithmic RF level detector 230, such as a successive compression detector, where it is amplified and converted into a current signal. A successive compression detector is but one type of circuit that may be employed as a logarithmic RF level detector 230, and those of ordinary skill in the art are aware of other detectors that may be substituted with equal efficacy. This amplified second signal is then passed to the summing cell 290 where it is summed along with the current values from the upper or first branch 215 to produce a combined current output 295 for the radio frequency level detector 200. Referring again to FIG. 4 where the curve 405 depicts the output current as a function of RF input power for the lower branch 210 of the level detector 200, note that the first portion 406 of the curve is essentially flat and remains generally constant as the RF power increases, up to approximately −10 dB, whereupon the slope of the curve continually changes through a transition region until about 0 dBm where the slope becomes constant and the log of the amp output increases smoothly and generally monotonically in the second portion 407 over further increases in RF power. Note that the current output values (y axis values) of the first portion 406 of the lower branch 210 are very small compared to the respective values in the first portion 402 of the upper branch 215 output. At the left end of the curve, the values approximate zero, and increase only marginally until about −10 dBm. Generally, the current output values of the lower branch are less than one tenth of the value of respective portions of those of the upper branch over the first range. When the current signals for both the upper and lower branch are summed at the summing cell 290 to produce a combined output 295, the two curves are superimposed to create the result depicted in the topmost curve 410 in FIG. 4. Note that the combined current output signal 410 that increases smoothly and monotonically as a function of radio frequency power over the entire range of RF power.

This embodiment functions in a manner similar to that depicted by the structure of FIG. 1, except signal rectification in the low and intermediate range input power branches is performed after the signal is sampled at the output of each limiting amplifier. This leads to the additional constraint that each of the rectifiers in the upper branch of FIG. 2 must be linear (i.e. no squaring cells). Each of the limiting amplifier cells in the embodiment depicted in FIG. 2 operates at the RF carrier frequency, whereas in FIG. 1 they do not. As in the previous embodiment, this embodiment can be expanded to include additional branches. Each of the additional branches must be of the same type as the upper branch, and transconductance cells can be placed at any point along the chain except at the input or output of the first limiting amplifier.

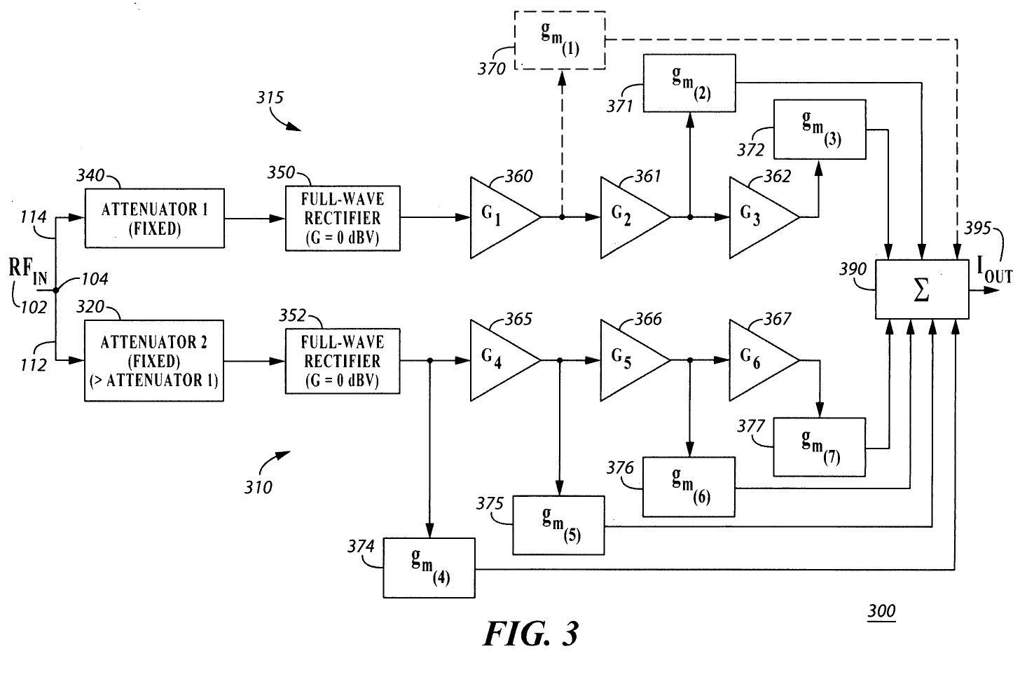

FIG. 3 illustrates yet another embodiment implemented with three limiting amplifier stages in the upper branch, and a 3-stage successive detection logarithmic level detector in the lower branch. A radio frequency level detector 300 is arranged to receive an RF signal 102 at an input node 104. The RF signal 102 is split into two signals 112, 114 and sent to two parallel branches 310, 315 of the detector 300. The first or upper branch 315 contains a fixed attenuator 340 coupled to a full wave rectifier 350 coupled to three serially coupled limiting amplifier stages 360, 361, 362 and two voltage-to-current converters 371, 372. The fixed attenuator 340 receives the RF signal 102, attenuates it at a predetermined value, and then passes the attenuated signal to the rectifier 350, where it is rectified to create a rectified signal that is proportional to the envelope of the radio frequency signal 102. The rectified signal is then passed to the three limiting amplifiers 360, 361, 362 that are serially connected, the output of one to the input of the next. Each sequential amplification stage increases the level of the RF signal, and after each amplification stage, the signal is passed to the next amplifier in the chain. The final two limiting amplifiers have associated with them a transconductance cell (voltage-to-current converter) 371, 372 at the output of the amplifier, where the voltage signal is converted to a current signal. All the current signals are passed to a common summing cell 390 that sums up all the values to create a summed value for the amplified upper branch signal. The result of this manipulation of the original RF signal 102 is a current signal that increases monotonically as a function of radio frequency power over a first range of RF power, and at a certain point, stops increasing and remains substantially constant as a function of radio frequency power over the remainder of the power range.

Optionally, an additional transconductance cell 370 may be added at the output of the first limiting amplifier 360, and tied to the summing cell 390, as shown by the dashed lines in FIG. 3. As described above, this transconductance cell is not normally present in this embodiment, but may be added as the circuit designer desires.

The second or lower branch 310 is similar to the upper branch 315 of the radio frequency level detector 300 in that it also contains a fixed attenuator 320 coupled to a full wave rectifier 352 coupled to three serially coupled limiting amplifier stages 365, 366, 367 which are coupled to four voltage-to-current converters 374, 375, 376, 377. This fixed attenuator 320 receives the raw RF signal 102 and has an attenuation factor that is larger than the fixed attenuator 340 in the upper or first branch 315. The reason for this is to produce an output that is essentially flat over the first portion or range of the power curve. The attenuator 320 clips the RF signal so that the output is very small compared to the respective output of the first or upper branch 315 of the circuit over the same range of RF power input. The fixed attenuator 320 then passes the attenuated signal to the rectifier 352, where it is rectified to create a rectified signal that is proportional to the envelope of the radio frequency signal 102. The rectified signal is then passed to a series of three serially connected limiting amplifiers 365, 366, 367. Each limiting amplifier has associated with it a transconductance cell 375, 376, 377 at the output of the amplifier, and the first limiting amplifier 365 has a transconductance cell 374 tied to a common node between the output of the rectifier 352 and the input of the amplifier 365. Each sequential amplification stage increases the level of the RF signal, and after each amplification stage, the signal is passed to the next amplifier in the chain, and it is also passed to an associated transconductance cell, where the voltage signal is converted to a current signal. Each of the transconductance cells passes their current signals to a common summing cell 390 where they are summed along with the current values from the upper or first branch 315 to produce a combined current output 395 for the radio frequency level detector 300. The curve 405 FIG. 4 depicts the output current as a function of RF input power for the lower branch 310 of the level detector 300. Note that the first portion 406 of the curve is essentially flat and remains generally constant as the RF power increases, up to approximately −10 dBm, whereupon the curve increases smoothly and generally monotonically in the second portion 407 over further increases in RF power. Note that the current output (y axis values) of the first portion 406 of the lower branch 310 are very small compared to the respective values in the first portion 402 of the upper branch 315 output. Generally, the current output values of the lower branch are less than one tenth of the value of respective portions of those of the upper branch over the first range. When the current signals 401, 405 for both the upper and lower branch are summed at the summing cell 390 to produce the combined output 395, the two curves are superimposed to create the result depicted in the topmost curve 410 in FIG. 4. Note that the combined current output signal 410 increases smoothly and monotonically as a function of radio frequency power over the entire range of RF power. FIG. 4 demonstrates that the instant invention achieves nearly ideal log-linear performance over an input RF power range of −38 dBm to 12 dBm. Through proper choice of the amplifier gains and transconductance values in the upper and lower branches, the transition between the upper and lower branches is essentially unseen. The upper branch output 401 demonstrates the effect of omitting the transconductance cell at the input and output of the first limiting amplifier 360. For values of RF_{IN}>˜−7 dBm, the upper branch forms an output current ‘pedestal’ on which the output current from the lower branch is superimposed. It should be noted that both branches in FIG. 3 are operational at all input power levels. Therefore, no variable attenuators (and no associated control logic) are required in order to select the appropriate branch as a function of input power level. Although the embodiment depicted here contains two branches, the structure is easily expanded to incorporate additional branches, but each of the additional branches must be of the same form as the upper branch 315.

In summary, without intending to limit the scope of the invention, this architecture allows the fabrication of a wide dynamic range RF power detector using relatively inexpensive semiconductor fabrication processes. For example, the RF components in FIG. 3 would only have to cover approximately 28 dB of dynamic range, instead of the full 50 dB range [−38 dBm, 12 dBm]. Because the lower branch has a larger attenuator preceding it, while the upper branch rectifier is in compression, the lower branch rectifier will be entering its linearity ‘sweet spot’. Those skilled in the art will recognize that while the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

1. A radio frequency level detector, comprising:
a branching circuit for receiving a radio frequency signal and for providing said signal to at least two separate branches, the first of said two separate branches comprising:
a first fixed attenuator coupled to receive said radio frequency signal;
a rectifier coupled to an output of said first fixed attenuator, providing a rectified output that is proportional to an envelope of the radio frequency signal;
a plurality of N serially coupled limiting amplifier stages, where N is equal to or greater than 2, each having an input and an output, wherein the input of a first amplifier stage is coupled to the rectifier to receive the rectified signal;
a plurality of (N−1) voltage-to-current converters, each having an input and an output, the input coupled to the output of the respective second through Nth serially coupled limiting amplifier stages; and
wherein the outputs of each of the plurality of voltage-to-current converters are coupled to a summing cell;
the second of said two separate branches comprising:
a second fixed attenuator coupled to said radio frequency signal, said second fixed attenuator being larger than the first fixed attenuator; and
a radio frequency level detector circuit having an input coupled to an output of said second fixed attenuator and providing an output to said summing cell; and
wherein the outputs of the two branches are combined to provide a single output signal.

2. The radio frequency level detector as described in claim 1 wherein the rectifier comprises a full wave rectifier, a half wave rectifier, or a squaring cell.

3. The radio frequency level detector as described in claim 1 wherein said first separate branch comprises a limiting successive compression detector.

4. A radio frequency level detector, comprising:
branching means for receiving a radio frequency signal and for providing said signal to at least two separate branches, the first of said two separate branches comprising:
first means for attenuating said signal at a fixed attenuation value;
means for rectifying said attenuated signal, for providing a rectified output that is proportional to an envelope of the radio frequency signal;
first means for amplifying the rectified signal, coupled to the output of the means for rectifying;
second through Nth means for amplifying, where N is an integer greater than 2, serially coupled to the first means for amplifying and to each other; and
means for converting, coupled to the output of each respective second through Nth means for amplifying, for converting the respective amplified signals from voltage to current;
the second of said two separate branches comprising:
second means for attenuating said signal at a fixed attenuation value, said second means for attenuating having a larger attenuation value than the first means for attenuating; and
radio frequency level detecting means, having an input coupled to the output of said second means for attenuating, and outputting a current signal; and
means for summing all of the current signals from the first and second branches to provide a combined current signal.

5. The radio frequency level detector as described in claim 4 wherein the means for rectifying comprises a full wave rectifier, a half wave rectifier, or a squaring cell.

6. The radio frequency level detector as described in claim 4 wherein said first separate branch comprises a limiting successive compression detector.

7. A method of extending the dynamic range of a radio frequency level detector, comprising:
receiving a radio frequency (RF) signal and providing said RF signal to at least two separate branches to provide a first RF signal and a second RF signal;
processing said first RF signal sufficient to provide a first current output signal that increases monotonically as a function of radio frequency power over a first predetermined range and remains substantially constant as a function of radio frequency power over a second predetermined range, by means of:
attenuating said first RF signal with a fixed value attenuator;
rectifying said attenuated first RF signal to provide a signal that is proportional to an envelope of the radio frequency signal;
sequentially amplifying the rectified signal through a plurality of serially coupled limiting amplifier stages; and
after the second amplification, converting each amplified signal to current;
processing said second RF signal sufficient to provide a second current output signal that is substantially smaller than respective portions of said first current output signal over said first predetermined range and is substantially constant as a function of radio frequency power, and that increases monotonically as a function of radio frequency power over said second predetermined range, by means of:
attenuating said second RF signal at a fixed value that is greater than the attenuation of the first RF signal; and
amplifying the attenuated second RF signal to provide a second current output signal; and
summing the first and second current output signals to provide a combined current output signal that increases monotonically as a function of radio frequency power over said first predetermined range and over said second predetermined range.

8. The method of extending the dynamic range of a radio frequency level detector as described in claim 7 wherein the step of rectifying comprises rectifying with a full wave rectifier, a half wave rectifier, or a squaring cell.

9. The method of extending the dynamic range of a radio frequency level detector as described in claim 7 wherein the step of amplifying said second signal comprises amplifying said second signal so as to provide a current output signal that is less than one tenth of the value of respective portions of said first signal over said first predetermined range.

10. A method of extending the dynamic range of a radio frequency level detector, comprising:
receiving a radio frequency signal and providing said signal to at least two separate branches to provide a first signal and a second signal;
amplifying said first signal sufficient to provide a current output signal that increases substantially uniformly as a function of radio frequency power over a first predetermined range and remains substantially constant as a function of radio frequency power over a second predetermined range;
amplifying said second signal sufficient to provide a current output signal that is small compared to respective portions of said first amplified signal over said first predetermined range, and that increases substantially uniformly as a function of radio frequency power over said second predetermined range; and
summing all the current output signals to provide a combined current output signal that increases substantially uniformly as a function of radio frequency power over said first predetermined range and over said second predetermined range.

11. The method of extending the dynamic range of a radio frequency level detector as described in claim 10, wherein the step of amplifying said second signal comprises providing a current output signal that is less than one tenth of the value of respective portions of said first signal over said first predetermined range.

12. The method of extending the dynamic range of a radio frequency level detector as described in claim 10, wherein the step of amplifying said second signal comprises providing a current output signal that is generally constant over said first predetermined range.

13. A radio frequency level detector, comprising:
a branching circuit for receiving a radio frequency signal and for providing said signal to at least two separate branches, the first of said two separate branches comprising:
a first fixed attenuator coupled to receive said radio frequency signal;
a plurality of N serially coupled limiting amplifier stages, where N is equal to or greater than 2, each having an input and an output, wherein the input of the first amplifier stage is coupled to the first fixed attenuator;
a plurality of (N−1) voltage-to-current converters, each having an input and an output, the input coupled to the output of the respective second through Nth serially coupled limiting amplifier stages;
a rectifier coupled to the output of each voltage-to-current converter, providing a rectified current output signal; and
wherein the outputs of each of the rectifiers are coupled to a summing cell;
the second of said two separate branches comprising:
a second fixed attenuator coupled to said radio frequency signal, said second fixed attenuator being larger than the first fixed attenuator; and
a radio frequency level detector circuit having an input coupled to an output of said second fixed attenuator and providing an output to said summing cell; and
wherein the outputs of the two branches are combined to provide a single output signal.

14. A radio frequency level detector, comprising:
branching means for receiving a radio frequency signal and for providing said signal to at least two separate branches, the first of said two separate branches comprising:
first means for attenuating said signal at a fixed attenuation value;
first means for amplifying the attenuated signal, coupled to an output of the means for attenuating;
second through Nth means for amplifying, where N is an integer greater than 2, serially coupled to the first means for amplifying and to each other;
means for converting, coupled to an output of each respective second through Nth means for amplifying, for converting the respective amplified signals from voltage to current; and
means for rectifying said converted signals, for providing rectified current output signals;
the second of said two separate branches comprising:
second means for attenuating said signal at a fixed attenuation value, said second means for attenuating having a larger attenuation value than the first means for attenuating; and
radio frequency level detecting means, having an input coupled to an output of said second means for attenuating, and having a current signal output; and
means for summing all of the current output signals from the first and second branches to provide a combined current output signal.

15. A method of extending the dynamic range of a radio frequency level detector, comprising:
receiving a radio frequency signal and providing said signal to at least two separate branches to provide a first signal and a second signal;
amplifying said first signal sufficient to provide a current output signal that increases monotonically as a function of radio frequency power over a first predetermined range and remains substantially constant as a function of radio frequency power over a second predetermined range, by means of:
attenuating said first signal with a fixed value attenuator;
sequentially amplifying the attenuated first signal through a plurality of serially coupled limiting amplifier stages;
after the second amplification, converting each amplified signal into a current signal; and
rectifying said converted signal to provide a rectified current output signal;
amplifying said second signal sufficient to provide a current output signal that is substantially smaller than respective portions of said first amplified signal over said first predetermined range and is substantially constant as a function of radio frequency power, and that increases monotonically as a function of radio frequency power over said second predetermined range, by means of:
attenuating said second signal at a fixed value that is greater than the attenuation of the first signal; and
amplifying the attenuated second signal to provide a current output signal; and
summing all the current output signals to provide a combined current output signal that increases monotonically as a function of radio frequency power over said first predetermined range and over said second predetermined range.

16. The method of extending the dynamic range of a radio frequency level detector as described in claim 15 wherein the step of amplifying said second signal comprises amplifying said second signal so as to provide a current output signal that is less than one tenth of the value of respective portions of said first signal over said first predetermined range.

17. A radio frequency level detector, comprising:
a branching circuit for receiving a radio frequency signal and for providing said signal to at least two separate branches, the first of said two separate branches comprising:
a first fixed attenuator coupled to receive said radio frequency signal;
a rectifier coupled to an output of said first fixed attenuator, providing a rectified output that is proportional to an envelope of the radio frequency signal;
a plurality of N serially coupled limiting amplifier stages, where N is equal to or greater than 2, each having an input and an output, wherein the input of a first amplifier stage is coupled to the rectifier output;
a plurality of (N−1) voltage-to-current converters, each having an input and an output, the input coupled to the output of the respective second through Nth serially coupled limiting amplifier stages; and
wherein the outputs of each of the plurality of voltage-to-current converters are coupled to a summing cell;
the second of said two separate branches comprising:
a second fixed attenuator coupled to said radio frequency signal, said second fixed attenuator being larger than the first fixed attenuator;
a rectifier coupled to an output of said second fixed attenuator, providing a rectified output that is proportional to the envelope of the radio frequency signal;
a plurality of N serially coupled limiting amplifier stages, where N is equal to or greater than 2, each having an input and an output, wherein the input of a first amplifier stage is coupled to the rectifier output;
a plurality of voltage-to-current converters, each having an input and an output, the input of the first converter coupled to the output of the rectifier, and the inputs of each of the remainder of the converters coupled to the output of each respective serially coupled limiting amplifier stage; and
wherein the outputs of each of the plurality of voltage-to-current converters are coupled to the summing cell; and
wherein the outputs of the first and second branches are combined to provide a single current output signal.

18. The radio frequency level detector as described in claim 17 further comprising an additional voltage-to-current converter coupled to the output of the first limiting amplifier stage in the first branch.

19. A radio frequency level detector, comprising:
branching means for receiving a radio frequency signal and for providing said signal to at least two separate branches, the first of said two separate branches comprising:
first means for attenuating said signal at a fixed attenuation value;
means for rectifying said attenuated signal, for providing a rectified output that is proportional to an envelope of the radio frequency signal;
first means for amplifying the rectified signal, coupled to an output of the means for rectifying;
second through Nth means for amplifying, where N is an integer greater than 2, serially coupled to the first means for amplifying and to each other; and
means for converting, coupled to the output of each respective second through Nth means for amplifying, for converting the respective amplified signals from voltage to current;
the second of said two separate branches comprising:
second means for attenuating said signal at a fixed attenuation value, said second means for attenuating having a larger attenuation value than the first means for attenuating;
means for rectifying said attenuated signal, for providing a rectified output that is proportional to the envelope of the radio frequency signal;
N means for amplifying, where N is an integer equal to or greater than 2, serially coupled to the means for rectifying and to each other; and
means for converting, coupled to the output of each respective N means for amplifying and to the output of the means for rectifying, for converting the respective signals from voltage to current; and
means for summing all of the current signals from the first and second branches to provide a combined current signal.

20. A method of extending the dynamic range of a radio frequency level detector, comprising:
receiving a radio frequency signal and providing said signal to at least two separate branches to provide a first signal and a second signal;
amplifying said first signal sufficient to provide a first current output signal that increases monotonically as a function of radio frequency power over a first predetermined range and remains substantially constant as a function of radio frequency power over a second predetermined range, by means of:
attenuating said first signal with a fixed value attenuator;
rectifying said attenuated first signal to provide a signal that is proportional to an envelope of the radio frequency signal;
sequentially amplifying the rectified first signal through a plurality of serially coupled limiting amplifier stages; and
after the second amplification, converting each amplified signal to current;
amplifying said second signal sufficient to provide a second current output signal that is substantially smaller than respective portions of said first current output signal over said first predetermined range and is substantially constant as a function of radio frequency power, and that increases monotonically as a function of radio frequency power over said second predetermined range, by means of:
attenuating said second signal at a fixed value that is greater than the attenuation of the first signal;
rectifying said attenuated second signal to provide a signal that is proportional to the envelope of the radio frequency signal;
sequentially amplifying the rectified second signal through a plurality of serially coupled limiting amplifier stages; and
converting each amplified signal to current; and
summing the first and second current output signals to provide a combined current output signal that increases monotonically as a function of radio frequency power over said first predetermined range and over said second predetermined range.

21. The method of extending the dynamic range of a radio frequency level detector as described in claim 20 wherein the step of amplifying said second signal comprises amplifying said second signal so as to provide a current output signal that is less than one tenth of the value of respective portions of said first signal over said first predetermined range.

22. The method of extending the dynamic range of a radio frequency level detector as described in claim 20, wherein the step of amplifying said second signal further comprises converting the rectified signal to current.
